(19) United States
(12) Patent Application Publication
(10) Pub. No.: US 2013/0105060 A1
(43) Pub. Date: May 2, 2013

(54) SYSTEM FOR APPLYING ADHESIVES

(71) Applicant: Christopher D. Shay, Horseshoe Bay, TX (US)

(72) Inventor: Christopher D. Shay, Horseshoe Bay, TX (US)

(21) Appl. No.: 13/662,513

(22) Filed: Oct. 28, 2012

Related U.S. Application Data
(60) Provisional application No. 61/553,195, filed on Oct. 30, 2011.

(51) Int. Cl. B32B 37/12; B67D 1/00

(52) U.S. Cl. 156/60; 222/82

(57) ABSTRACT

A system of adhesive or epoxy containing sealed wells or packets is formed in sheets and combined with a puncturing web or internal puncturing barbs to form multilayer laminates or pads. When pressure is applied to the pads, the packets rupture to dispense, mix and distribute the adhesive material between surfaces to be adhered.

### CROSS-REFERENCE TO RELATED APPLICATIONS

This application claims benefit of priority to U.S. Provisional Application 61/553,195 filed Oct. 30, 2011, the disclosure of which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of adhesives and adhesive application systems. More particularly, the present invention is in the technical field of devices for the application of liquid adhesives for attaching two or more surfaces.

### BACKGROUND OF THE INVENTION

Present adhesive systems rely upon manual metering of the fluid or fluids onto a surface to be adhered to another. The application types, devices and systems are numerous. One example of a one part adhesive application is the installation of tiles to floors or walls whereby the thinset or adhesive material is withdrawn from a large volume container and troweled onto the at least one surface. Such application suffers from the drawbacks of uneven application, inconsistent or excessive quantity applied, and environmental and personal exposure of the adhesive solvent. Additionally, such applications are time-consuming, wasteful, and require clean-up.

Two-part epoxy adhesives are commonly dispensed from a dual-dispense, two- chambered system or sequentially from two separate containers. Typically, the two parts are manually mixed after dispensation or in certain systems, are premixed as they pass through a mixing nozzle attached to the dual-chambered container. In both systems, the amount dispensed and the degree of mixing are both highly variable and suffer from the same drawbacks mentioned above.

A more specialized adhesive application system is used in the field of roadway marker placement. The markers, commonly referred to as raised roadway or pavement reflectors, are placed onto the pavement to delineate boundaries for drivers. Typically the plastic, ceramic, or glass reflectors are adhered to the asphalt, concrete or chip seal surface by use of a two-part epoxy. Alternatively, a single-part bitumen type of adhesive composed of a homogeneous mixture of asphalt binder and mineral filler is heated in a truck mounted vat and pumped onto the surface onto which the marker is then embedded. The advantage of the bitumen is a fast cure time, though some fast setting epoxies may also be commonly used. Each of these systems requires specialized mixing and/or heating and pumping equipment which is often truck mounted to provide for fast automated marker placement in large numbers on roadways. The disadvantages of these systems and methods are numerous and primarily include that excessive quantity of adhesive is necessary to assure adequate adhesion, which results in unnecessarily excessive environmental and worker exposure to volatile organic compounds (VOCs), as well as the need for expensive high maintenance equipment.

The present disclosure provides a system for containing and dispensing exact quantities of single-part adhesives or multi-part epoxies. A plurality of individual liquid containing wells can be formed in sheets of rows, columns or in a staggered or honeycomb arrangement of a prescribed volume and number. Once formed in continuous sheets, the arrays of wells can be filled with the liquid adhesive or in the case of a multi-part epoxy, the separate components may be filled into adjacent or neighboring wells of the same sheet or matrix. Once filled, the wells can be enclosed or sealed with a lidding material to form fully enclosed packets of fluid.

Alternatively, preformed packets can be filled by injection and subsequently sealed. The sheets of packets can be cut to size to form pads of variable dimensions to fit the surfaces to be attached. The pads of packets are fitted on one side with a web that includes pointed protrusions and lateral and vertical spacing elements. Additional layers can be added to form a multi-layer laminate for ease of handling and application. For example, peel and stick meshing can be placed on top and bottom of the pads to allow for affixing the pad to the surfaces to be adhered. Once positioned between two surfaces, pressure is applied and the web punctures the individual packets which releases the liquid pressurized by the compression. The web then aids in the mixing and distribution of the adhesive material or multi-part epoxy between the two surfaces to be adhered.

The advantages of the present invention include primarily precise application of an exact quantity of adhesive materials that can be tailored to the specific application intended. The resulting benefits are speed of application, reduced VOC liberation, handling exposure, mess and cleanup requirements. In the case of pavement markers specifically, the present invention obviates the need for large, complex and expensive machinery to apply the markers.

### SUMMARY OF THE INVENTION

The present invention is a system that contains, dispenses and mixes single or multi-part adhesives and epoxies. The system includes a geometric assemblage of liquid containing sealed wells that are of a prescribed number, size and total volume. Spiny barbs are located either inside each well individually, or arranged in a connected web or netting external to and around the wells. The liquid containing wells are formed from a rupturable material that when compressed, causes the interior contents to pressurize and the walls to bulge outward. When the walls contact the pointed protrusions, the liquid contents are expelled, intermingle and diffuse between the two surfaces to be adhered.

### BRIEF DESCRIPTION OF THE DRAWINGS

FIG. 1 is a view of the present invention of an adhesive pack containing an array of adhesive containing packets or wells fitted with an activating web of barbs for dispensing and mixing the adhesive material. Item 100 is a sheet of formed wells 102 perforated 104 to allow for adequate vertical flow of liquid once discharged. Item 106 gives the well lidding or sealing layer where solid sections 108 that enclose the liquid filled wells provide for sealing surfaces. The lidding material is perforated 110 similar to the well sheet to allow for material flow. Item 112 is the puncturing web of barbs that includes pointed protrusions 114 and spacers 116 to ensure correct vertical and alignment. The web is sandwiched with the adhesive pack and its position may be maintained with a self-adhering porous or mesh layer 118a placed beneath the adhesive pack. A similar layer may be included on top of the pack 118b to allow for ease of handling and to aid in affixing the entire pad system to the surfaces to be adhered.

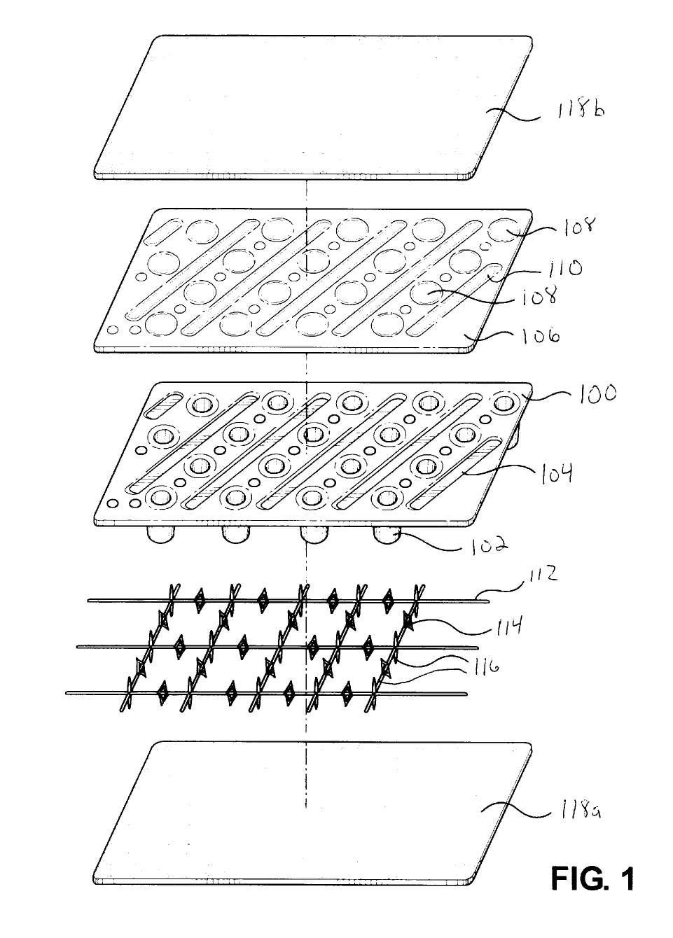

FIG. 2 provides an alternative embodiment of an adhesive pack of the present invention. Similar to FIG. 1, Item 100 is a sheet of formed wells 102 perforated 104 to allow for adequate vertical flow of liquid once discharged. Item 106 gives the well lidding or sealing layer where solid sections 108 that enclose the liquid filled wells provide for sealing surfaces. The lidding material is perforated 110 similar to the well sheet to allow for material flow. Item 200 is one barb that includes pointed protrusions 202, but in this embodiment is located within one or more of the individual wells or packets 102. The web is similarly sandwiched with the adhesive pack and its position may be maintained with a self-adhering porous or mesh layer 118a placed beneath the adhesive pack. A similar layer may be included on top of the pack 118b to allow for ease of handling and to aid in affixing the entire pad system to the surfaces to be adhered.

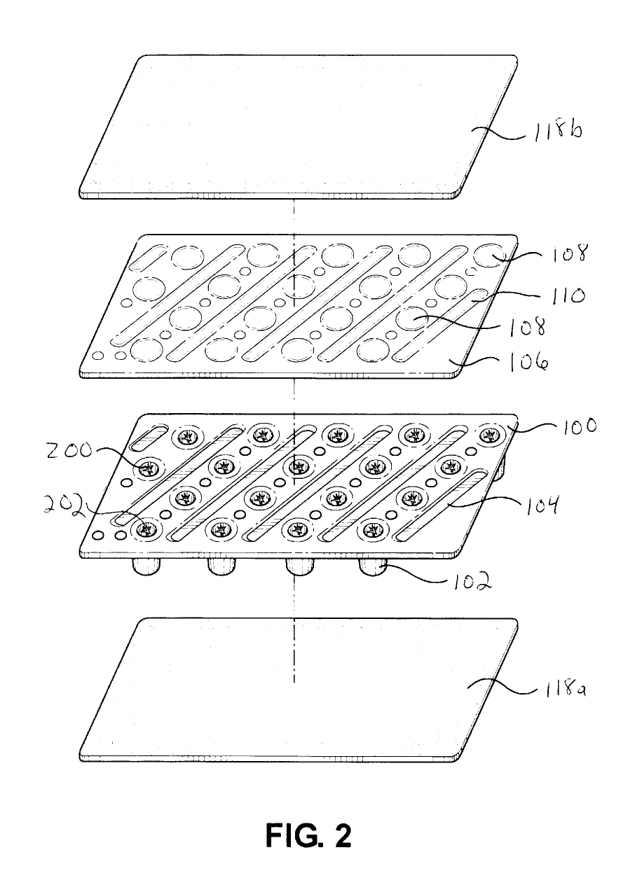

### DETAILED DESCRIPTION OF THE INVENTION

Embodiments of the present invention provide for a system to quickly, accurately, cleanly and with minimal environmental exposure, contain, transport, apply and dispense adhesives either as individual components or as multi-part epoxies.

In preferred embodiments, the wells or packets 102 that contain the liquids are formed in an apparatus by either cold or warm forming methods well known in the arts of web handling and continuous sheet rolling, extrusion and forming methods. In those methods, for example, a sheet of plastic, polymeric, or multi-component metal, plastic, or metal-plastic laminates, where for example the metallic layer is aluminum are continuously rolled between two contacting plates in which pins or dowels are pushed upon the web to extrude or shape the well. These methods may apply heat and or alternatively or in additional steps, cold to facilitate the forming and recrystallization of the base material. Once formed, the well would typically progress to a filling station that would pump or inject the liquid adhesive in a known quantity. The web or sheet 100 of formed wells then progresses to a subsequent station where a sealing layer 106 is rolled atop the base of wells and the seal 108 is provided by heat welding of the polymeric layers or other means, such as ultrasonic welding and/or use of an adhesive.

In certain other exemplary embodiments, prior to the placement of the sealing layer, a barb 200 or other internal device may be placed into the well before or after the liquid is introduced. Discussed in greater detail below, the spiny, barbed object may be metallic or plastic and provide for pointed protrusions 202 for the purpose of aiding in the rupturing the wells upon compression.

The web of sealed wells, with or without internal barbs, then go through one or more steps that section the sheets into the dimensions desired and may additionally provide for perforations or openings 104,110 in the sheet material between individual wells 102 to allow for greater flow and distribution of the liquid upon ejection to provide for improved mixing and contact between the surfaces to be adhered.

In certain preferred embodiments, the sheets of sealed wells may be sectioned into a grid, matrix, array, or pattern or other geometric arrangement of wells to include but not limited to a grid or orthogonal arrangement of wells, a single linear arrangement, or a staggered or honeycomb arrangement. A multitude of other arrangements is possible depending upon the shape, size and geometry of the surfaces to be adhered. For the purposes of this disclosure, general use of the term “matrix” when describing a set of connected wells or packets should be construed as inclusive of any of the aforementioned or other similar geometries or arrangements of more than one well or packet.

In certain preferred embodiments, the wells 102 may be tailored by design such the total volume of adhesive material applied per unit surface area may be adjusted to deliver a more or a less quantity of adhesive. In this manner, a specific or preferred given quantity of a thinset, epoxy or other adhesive may be called for and the number and size of individual wells adjusted to deliver that quantity. In one exemplary embodiment, a typical tile of size 12 inch by 12 inch may require a nominal volume of thinset of 250 mL which may be divided between a matrix of 576 wells arranged in a configuration of 24 by 24, with each well containing approximately 0.5 mL of adhesive.

In certain other preferred embodiments, the size of the wells 102 may be increased to allow for inclusion of a minimal gas or head space volume that may contain air, nitrogen or other inert compressible gas that may be used to tailor the internal pressure of the well when it undergoes compression and pressurization. For example, for a given array of N wells, each of volume V, arranged in a geometrically orthogonal array of X by Y; a prescribed design pressure in bars may be necessary to provide for adequate pressure to rupture the wells and dispense the contents. In this manner, the headspace may be adjusted to increase or lower that required pressure in conjunction with the size and spacing of the wells as designed to deliver a particular quantity of adhesive material.

In one exemplary embodiment using the above 12 inch by 12 inch tile as but one example, the 0.5 mL well volume may be increased nominally 5% to 50% to adjust the internal pressure and force required to expel the contents. This gas space design factor may also take into account the size or spacing of the puncturing component discussed in more detail below. In certain embodiment, the gas space may be adjusted to allow greater pre-rupture bulging of the compressed well, in which case the spacing or size of barbs may be less or more to provide for rupture of the wells at a prescribed pressure. In this manner, the dispense pressure can be tailored to provide for greater or less expulsion force, which has effects on the degree of mixing and distribution of the adhesive or epoxy. These design factors, combined with others described below, then provide for multiple degrees of design freedom to precisely meet the needs of a great range of applications.

In preferred embodiments it will be apparent to those skilled in the art of packaging that the material that forms the wells 102 may be engineered to deliver a designed for stiffness or ease at which rupture will occur to include rupturing without use of either external or internal puncturing barbs, devices or mechanisms. To that end, the primary design factors include the pre-forming and post-forming thickness, material structure, final well shape and composition of the material or multi-layered laminate. In one particular exemplary embodiment, the wells are formed from sheets of polyethylene that are a 100 to 300 mil preformed thickness and the final post-formed wells a 2 to 10 mil in thickness, for example, with each step change in final thickness prescribing a differing required burst or rupture pressure depending upon the volume, shape and gas headspace contained within.

In certain other embodiments where a two or more part epoxy system were desired, alternating wells 102 may be filled with complementary members of the epoxy pair. Depending upon the required volume ratio or the epoxy components, the geometry of the well arrays may be modified, for example to form a honeycomb arrangement, whereby the central well may be filled with Part A while the surrounding wells with Part B or other components such that the combination of the well array and volumes of individual components can be modified by design to best dispense the adhesive system of interest.

As mentioned above, the individual wells 102 may contain metallic or preferentially plastic barbs or devices 112,200 with pointed or blunt protrusions 114 that upon pressurization of the well, facilitates the rupturing and dispensation of the contents. In certain other preferred embodiments, that barb may be located external to the web and may be included in a web of connected barbs 112 that forms a sheet that fits the matrix of wells. Placed either internally or externally, the barbs may be termed as an ‘activating’ device or ‘activating sheet’ or ‘puncturing web’ whereby the individualized or network of barbs provides the means of puncturing and releasing the components and further; aid in the mixing and distribution of the adhesive or multiple part epoxy system.

In certain exemplary embodiments the wells 102 may be substantially bubble shaped or hemispherical, cylindrical, or trapezoidal in cross-section and may be of variable depth and side wall angles. The volume of said wells may be adjusted according to the individual size required by the application within the limitations of the chosen material, chiefly its thickness and tensile characteristics and whether cold and/or warm formed.

In an externally located puncturing web 112, the individual barbs may be connected by members or spacers 116a/b that provide for vertical 116a and horizontal 116b alignment of the barb. The members may be made of the same material as the barb, for example, plastic which may be composed from a number of types or classes of polymeric materials including but not limited to polyethylene (PE), high-density polyethylene (HDPE), or polypropylene (PP) or poly styrene (PS) as well as number of other types of materials know in the art of moldable part making. In the case of polymeric barbs, the connecting members 116a/116b that form the activating web may be, in certain exemplary embodiments, injection molded as a large single sheet 112 which can then be sectioned from the larger web or sheet and individualized for the application of interest. In certain other alternative embodiments, the barbs may be made of metallic or composite material or of a cellulosic or other biodegradable matrix or material. The choice of material may be made in light of the needed stiffness of the material which accounts for the application specific needs, whereby for example, a less deflecting metallic or HDPE may be preferential in low headspace, high volume applications where the wells may require more force or pressure to rupture.

In preferred embodiments, the barbs 112/200 may include protrusions such as two linearly opposed, or three trigonally oriented, or four protrusions arranged as a tetrahedron. In preferred embodiments, the protrusions are pointed, but may also be rounded, blunt tipped or jagged in order to delay the rupture event and thus provide greater well pressurization prior to dispense. In yet other exemplary embodiments, the barb may be a single point attached to a base element or may contain additional features such as splines, channels, deflectors, or other elements intended to provide for liquid distribution after rupture.

The spacing between the pointed protrusions 114 of the barbs may be designed to accommodate greater or less pressurization of the wells. In one exemplary embodiment, where the mixing of highly viscous epoxy components may benefit from a higher pressurization of the liquid at rupture, then the barbs may be spaced further part to allow for greater compression of the well until such time as the bulging of the well first contacts the pointed protrusions. Similarly, less viscous materials may more readily flow and mix, thus require less pre-rupture pressurization. In that exemplary model, a higher or less headspace volume and closer located barbs may be preferential.

To aid in the placement of the pad or pack of adhesive containing wells and puncturing barbs or web; the various layers and components may be sandwiched between one or two or more peel and stick adhesive layers, strips or sections 118a/118b. Such layers may also provide for ease of transportation and storage of the packs in stacks or rolls. When ready to apply they may be available as already sized to interest or cut by hand or machine at the point of application. In this exemplary employment, a roll or larger sheet of wells, puncturing webs, and peel and stick adhesive layers may be cut to size to fit the application size and shape or in an alternative embodiment, may be supplied pre-cut to size in a stack of packs or on a roll as a single sheet with or without perforations to permit quick hand separation of the separate sections.

These are but a few of the engineering and design considerations which may be adapted to the needs of the adhesive and precise application of interest. Primary considerations, as provided in this disclosure, include but are not limited to the flow characteristics of the adhesive or epoxy liquid, the required volume to be applied, degree of mixing required, the setup or curing time, the required strength of the bond as well as other related issues such as environmental considerations, etc.

These aspects, though not discussed exhaustively in this disclosure are nonetheless readily known by those of ordinary skill in the various arts that employ the packaging and use of adhesives, epoxies, bonding, curing, or other similar or related agents and materials. Such considerations and engineering principles are numerous and may be readily derived by those skilled in those arts and having the benefit of this disclosure. Thus, the examples contained herein are for the purposes of illustrating exemplary embodiments of the invention and are not thus intended to limit the scope of the invention, but rather the claims alone define the boundaries and scope of the present invention.

1. A system for containing, storing, transporting and dispensing a predetermined quantity of a single component adhesive, multi-part epoxy, or similar agent, comprising:
a matrix of liquid containing sealed wells or packets;
a puncturing web located external to the matrix or array of wells or packets that includes pointed protrusions or barbs and further wherein said puncturing web includes connecting members to provide for spacing and positioning of the protrusions; and
wherein applying pressure compresses the liquid containing wells or packets pressurizing the liquid contents within the packets and deforming the packets to allow contact with the pointed protrusions of the puncturing web which punctures the packets and discharges the liquid or liquids.

2. The system of claim 1 further comprising one or more peelable adhesive layers as a sheet or mesh.

3. The system of claim 1 further wherein the puncturing web promotes mixing and distribution of adhesive material between the surfaces being adhered.

4. A system for containing, storing, transporting and dispensing a predetermined quantity of a single component adhesive, multi-part epoxy, or similar agent, comprising:
a matrix of liquid containing sealed wells or packets;
one or more puncturing barbs located internal to one or more of the liquid containing sealed wells or packets; and
wherein applying pressure compresses the liquid containing wells or packets pressurizing the liquid contents within the packets and deforming the packets to allow contact with the puncturing barb(s) which punctures the packets and permits the discharge of the liquid or liquids.

5. A method of adhering two surfaces, comprising:
placing between the two surfaces a matrix of adhesive or epoxy containing sealed wells or packets and one or more puncturing devices;
applying a sufficient force or pressure to the outermost surface to compress the sealed wells or packets; and
wherein said compression causes the wells to contact the puncturing web which ruptures the wells and releases the adhesives and/or epoxy between the surfaces.

6. The method of claim 5 further wherein the puncturing device is a web of connected puncturing barbs located external to the sealed wells or packets.

7. The method of claim 5 further wherein the puncturing device(s) is/are one or more individual puncturing barbs placed inside the sealed wells or packets.
